(19) United States
(12) Patent Application Publication
(10) Pub. No.: US 2023/0073260 A1
(43) Pub. Date: Mar. 9, 2023

(54) OPTIMIZATION SYSTEM

(71) Applicant: IHI CORPORATION, Tokyo (JP)

(72) Inventors: Eiichiro FUJIWARA, Tokyo (JP); Masao ONO, Tokyo (JP)

(73) Assignee: IHI CORPORATION, Tokyo (JP)

(21) Appl. No.: 18/049,538

(22) Filed: Oct. 25, 2022

Related U.S. Application Data
(63) Continuation of application No. PCT/JP2021/021767, filed on Jun. 8, 2021.

(30) Foreign Application Priority Data
Jul. 2, 2020 (JP) 2020-114689

(51) Int. Cl. G05B 13/02

(52) U.S. Cl. CPC G05B 13/024

(57) ABSTRACT

Provided is an optimization system (1) including: a plurality of individual systems (20); and a host system (12) configured to communicate to and from the individual systems (20). Each of the individual systems (20) includes: a device (electric device (30)) which is connected to an energy source (electric power system (22)), and is configured to receive energy from the energy source, or transmit energy to the energy source; and an optimization calculation module (50) configured to execute optimization calculation so that an objective function is minimized under a state in which parameters of the energy through the device are set to the objective function and a constraint condition, respectively. The host system (12) includes a host calculation module (70) configured to derive an incentive based on a plurality of optimization calculation results each derived by a corresponding one of the individual systems (20). The optimization calculation module (50) is configured to again execute the optimization calculation based on the incentive derived by the host calculation module (70).

### CROSS REFERENCE TO RELATED APPLICATIONS

This application is a continuation application of International Application No. PCT/JP2021/021767, filed on Jun. 8, 2021, which claims the benefit of priority to Japanese Patent Application No. 2020-114689 filed on Jul. 2, 2020, and contents thereof are incorporated herein.

### BACKGROUND ART

### Technical Field

The present disclosure relates to an optimization system for optimizing individual systems.

For example, in Patent Literature 1, there is disclosed a configuration in which an EV power station, an industrial electric power storage system, and a household electric power storage system are controlled by an aggregator as adjustment forces for electric power.

### CITATION LIST

### Patent Literature

Patent Literature 1: JP 6574466 B2

### SUMMARY

### Technical Problem

Incidentally, there are various types of individual systems, for example, a business site such as a plant, an electric power storage facility in which batteries are installed, and a charging station (EV power station). Optimization of minimizing an item (for example, electricity price) set in advance may be individually executed for such an individual system.

However, even when each individual system is optimized, a total of the plurality of individual systems may not be considered as optimal. Consequently, an effect of the optimization decreases.

The present disclosure has an object to provide an optimization system capable of suppressing a decrease in effect of optimization.

### Solution to Problem

In order to solve the above-mentioned problem, according to one aspect of the present disclosure, there is provided an optimization system including: a plurality of individual systems; and a host system configured to communicate to and from the plurality of individual systems, wherein each of the plurality of individual systems includes: a device which is connected to an energy source, and is configured to receive energy from the energy source, or transmit energy to the energy source; and an optimization calculation module configured to execute optimization calculation so that an objective function is minimized under a state in which parameters of the energy through the device are set to the objective function and a constraint condition, respectively, wherein the host system includes a host calculation module configured to derive an incentive based on a plurality of optimization calculation results each derived by a corresponding one of the plurality of individual systems, and wherein the optimization calculation module is configured to again execute the optimization calculation based on the incentive derived by the host calculation module.

Further, the plurality of optimization calculation results may each include a prediction value of a demand for energy received from the energy source in a corresponding one of the plurality of individual systems, and the host calculation module may be configured to derive a prediction value of a total imbalance amount being an index indicating an energy supply/demand balance obtained by totaling the plurality of individual systems based on the plurality of optimization calculation results, and to derive the incentive based on the prediction value of the total imbalance amount.

Further, the host calculation module may be configured to repeat the derivation of the incentive until the derived prediction value of the total imbalance amount falls within a predetermined range, and the optimization calculation module may be configured to repeat the optimization calculation based on the derived incentive each time the incentive is derived.

Further, the optimization calculation module may be configured to start the optimization calculation at each interrupt timing that arrives at a predetermined control cycle, and the host calculation module may be configured to start calculation based on one of the plurality of optimization calculation results at a timing of reception of the one of the plurality of optimization calculation results from any one of the plurality of individual systems.

### Effects of Disclosure

According to the present disclosure, a decrease in effect of optimization can be suppressed.

### BRIEF DESCRIPTION OF DRAWINGS

FIG. 1 is a schematic diagram of an optimization system according to an embodiment of the present disclosure.

FIG. 2 is a flowchart for illustrating a flow of an operation of an optimization calculation module of an individual system.

FIG. 3 is a table for showing an example of specifications.

FIG. 4 is a graph for showing an example of a transition of a prediction value of an electric power demand.

FIG. 5 is a graph for showing an example of a transition of an electric power use amount unit price.

FIG. 6 is a graph for showing another example of the transition of the prediction value of the electric power demand.

FIG. 7 is a graph for showing an example of an ON state and an OFF state of charge of batteries of vehicles.

FIG. 8 is a graph for showing another example of the transitions of the prediction values of the electric power demands.

FIG. 9 is a flowchart for illustrating a flow of an operation of an host calculation module.

FIG. 10 is a graph for showing an example of a relationship between the number of times of converging and a prediction value of a total imbalance amount.

FIG. 11 is a graph for showing an effect of the optimization system.

### DESCRIPTION OF EMBODIMENTS

Now, with reference to the attached drawings, an embodiment of the present disclosure is described in detail. The dimensions, materials, and other specific numerical values represented in the embodiment are merely examples used for facilitating the understanding of the disclosure, and do not limit the present disclosure otherwise particularly noted. Elements having substantially the same functions and configurations herein and in the drawings are denoted by the same reference symbols to omit redundant description thereof. Further, illustration of elements with no direct relationship to the present disclosure is omitted.

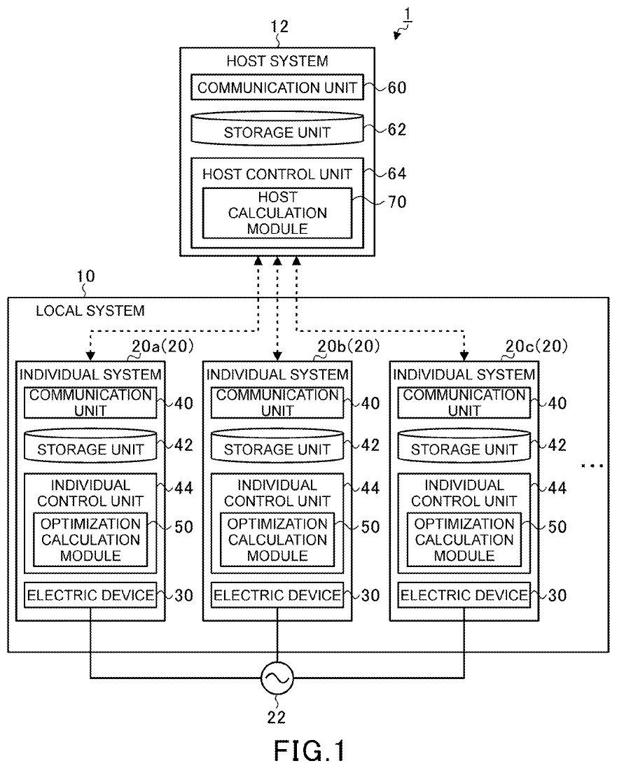

FIG. 1 is a schematic diagram of an optimization system 1 according to this embodiment. The optimization system 1 includes a local system 10 and a host system 12. The local system 10 is formed of a plurality of individual systems 20. In the example of FIG. 1, three individual systems 20a, 20b, and 20c are exemplified as the local system 10. The individual systems 20a, 20b, and 20c are hereinafter sometimes collectively and simply referred to as “individual system 20.” The number of individual systems 20 forming the local system 10 is not limited to three, and is only required to be two or more. The number thereof may be two, or four or more.

Each of the individual systems 20 includes an electric device 30 electrically connected to an electric power system 22. The electric power system 22 is an energy source of electric energy (electric power). The electric device 30 receives the electric power from the electric power system 22, or transmits electric power to the electric power system 22. The transmission of the electric power to the electric power system 22 corresponds to selling the electric power generated by the electric device 30 and the like to the electric power system 22.

In FIG. 1, for the convenience of description, one electric device 30 is exemplified in one individual system 20. However, the number of electric devices 30 included in the individual system 20 is not limited to one, and may be two or more. Moreover, when a plurality of electric devices 30 are present in the individual system 20, types of the plurality of electric devices 30 may be different from one another, or may be partially or entirely the same. Moreover, the types of the electric devices 30 in each individual system 20 may be different among the plurality of individual systems 20, or may be the same in a part or the entirety of the individual systems 20.

The individual system 20a is one of various types of business sites, for example, a plant, a warehouse, and an office. The electric device 30 of the individual system 20a is, for example, a motor, an air conditioning facility, or an illumination facility, and consumes the electric power of the electric power system 22.

The electric device 30 of the individual system 20b is, for example, a battery (storage battery). The battery is charged through use of the electric power supplied from the electric power system 22. Moreover, the battery can discharge the stored electric power to supply the electric power to the electric power system 22. The individual system 20b is, for example, a storage electric power facility in which the above-mentioned battery is installed. For example, the storage electric power facility may charge the battery when a load on the electric power system 22 is low, and may supply the stored electric power to the electric power system 22 when the load on the electric power system 22 is high.

The individual system 20c is, for example, a charging station (so-called “EV power station”) which can charge a battery of a vehicle. The vehicle herein is an electric vehicle, a hybrid vehicle, or the like on which a battery which supplies electric power to a drive source is mounted. A vehicle, such as an electric vehicle or a hybrid vehicle, is hereinafter sometimes referred to as “EV.” The electric device 30 of the individual system 20c is, for example, a charger which converts the electric power of the electric power system 22, and supplies the converted electric power to the battery of the EV. For example, in the individual system 20c, a plurality of chargers may be installed.

The electric device 30 is not limited to the specifically exemplified electric device 30, and may be any electric device which can receive or supply the electric power from or to the electric power system 22. Moreover, the individual system 20 is not limited to the exemplified individual system 20, and may appropriately be set based on the type, the scale, or the like of the electric device 30. Moreover, the plurality of individual systems 20 may be installed in premises different from one another, or a part or the entirety thereof may be installed in common premises.

The individual system 20 includes, in addition to the electric device 30, a communication unit 40, a storage unit 42, and an individual control unit 44. The communication unit 40 can establish wireless or wired communication to and from the host system 12. The storage unit 42 is formed of, for example, a nonvolatile storage device. In the storage unit 42, for example, various types of information used in the individual system 20 is stored.

The individual control unit 44 is formed of a semiconductor integrated circuit including a central processing unit (CPU), a ROM in which a program and the like are stored, a RAM being a work area, and the like. The individual control unit 44 executes a program, to thereby function as an optimization calculation module 50.

In the individual system 20, parameters of the energy (electric power) through the electric device 30 are set to an objective function and a constraint condition, respectively. The parameter set to the objective function and the parameter set to the constraint condition are parameters different from each other. The parameter herein is any item relating to, for example, an energy amount (electric power amount), an energy cost (electricity price), an energy efficiency (state of charge or energy conversion rate), an energy use time (electric power use time), an item relating to an energy use contract (for example, contracted electric power), an energy transmission/reception direction (for example, inhibition of reverse power flow), and the like.

The objective function corresponds to an item to be minimized in optimization described later. The objective function is set for each individual system 20. For example, in the individual system 20a, the electricity price at the business site is set as the objective function. Moreover, for example, in the individual system 20b, the number of charge/discharge cycles of the battery is set as the objective function. The charge/discharge cycle extends from a start of charge to a start of next charge through an end of the charge, or from a start of discharge to a start of next discharge through an end of the discharge. The number of charge/discharge cycles is the number of times of the charge/discharge cycles. Moreover, for example, in the individual system 20c, an error between a target value and a prediction value of a state of charge (SOC) at a scheduled charge end time of the battery of the EV is set as the objective function. In the individual system 20c, a difference between a target pattern and a predicted pattern of a driving pattern of the EV (in other words, an operation pattern of the charger) may be set as the objective function.

As the constraint condition, a condition to be observed in the optimization calculation is set. For example, in the individual system 20a, the contracted electric power at the business site and the reverse power flow inhibition condition are set as the constraint condition. Moreover, for example, in the individual systems 20b and 20c, an upper limit value of the SOC and a lower limit value of the SOC of the battery, and a charge/discharge electric power upper limit value and a charge/discharge electric power lower limit value are set as the constraint condition.

The optimization calculation module 50 executes optimization calculation so that the set objective function is minimized while observing the set constraint condition. The optimization calculation is executed in each individual system 20. A result obtained through the optimization calculation (optimization calculation result) includes a prediction value of a demand for energy (specifically, a demand for electric power) received from the energy source (electric power system 22) in the individual system 20. In this case, the electric power supplied from the individual system 20 to the electric power system 22 may be included as a negative electric power demand.

In more detail, the optimization calculation module 50 derives a transition of the prediction value of the electric power demand in a predetermined period after the current time in the individual system 20 at the time when the objective function is minimized. The predetermined period is, for example, from the current time to a time 24 hours later, but is not limited to this example, and may suitably be set.

For example, the optimization calculation module 50 of the individual system 20a derives the transition of the prediction value of the electric power demand in the business site at the time when the electricity price at the business site is the minimum. Moreover, the optimization calculation module 50 of the individual system 20b derives the transition of the prediction value of the electric power demand in the storage electric power facility at the time when the number of charge/discharge cycles is the minimum. The charge is the consumption of the electric power of the electric power system 22, and is thus considered as a positive electric power demand. Moreover, the discharge is the supply of the electric power to the electric power system 22, and is thus considered as a negative electric power demand. Further, the optimization calculation module 50 of the individual system 20c derives the transition of the prediction value of the electric power demand in the charging station at the time when the difference from the target value of the SOC is the minimum.

Moreover, the optimization calculation module 50 starts the optimization calculation at each interrupt timing that arrives at a predetermined control cycle (hereinafter sometimes referred to as “individual control start cycle”). One cycle of the individual control start cycle is set to, for example, 10 minutes or 15 minutes. The one cycle of the individual control start cycle is not limited to this example, and may be set to any time. That is, in each individual system 20, the optimization calculation result is updated substantially in real time each time the one cycle of the individual control start cycle elapses.

The individual control start cycles may be different from one another among the plurality of individual systems 20. Further, the timings (start timings of the optimization calculation) each at which the one cycle of the individual control start cycle has elapsed are asynchronous among the plurality of individual systems 20, but may be synchronous thereamong.

As described above, in the individual systems 20, each individual system 20 can be optimized, and the optimized transition of the prediction value of the electric power demand is obtained.

However, even when each individual system 20 is optimized, a total of the plurality of individual systems 20 may not be considered as optimal. For example, even when a supply/demand balance is optimal in each individual system 20, a supply/demand balance at the time when the plurality of individual systems 20 are totaled may not be optimal. Consequently, an effect of the optimization in each individual system 20 decreases. For example, in a case in which the plurality of individual systems 20 are operated by the same business entity or business entities in a cooperative relationship, the individual systems 20 are liable to be influenced by the decrease in the effect of the optimization.

In view of the above, in this embodiment, the host system 12 which can communicate to and from the individual systems 20 is provided. The host system 12 is installed by a business enterprise which provides services, such as management or information processing relating to the energy (electric power). The host system 12 may be provided by an electric power aggregator.

The host system 12 includes a communication unit 60, a storage unit 62, and a host control unit 64. The communication unit 60 can establish wireless or wired communication to and from the individual systems 20. The storage unit 62 is formed of, for example, a nonvolatile storage device. In the storage unit 62, for example, various types of information used in the host system 12 is stored.

The host control unit 64 is formed of a semiconductor integrated circuit including a central processing unit (CPU), a ROM in which a program and the like are stored, a RAM being a work area, and the like. The host control unit 64 executes a program, to thereby function as a host calculation module 70.

The host calculation module 70 acquires the optimization calculation result derived in the individual system 20 from each of the plurality of individual systems 20. The host calculation module 70 derives a prediction value of a future total imbalance amount based on the plurality of optimization calculation results each derived by a corresponding one of the individual systems 20. After that, the host calculation module 70 derives an incentive based on the prediction value of the total imbalance amount.

The imbalance amount is an index indicating an energy (electric power) supply/demand balance. The total imbalance amount is an index indicating an energy (electric power) supply/demand balance at the time when the plurality of individual systems 20 are totaled. For example, the total imbalance amount corresponds to a value obtained by subtracting an overall electric power demand amount of the plurality of individual systems 20 from an overall electric power supply amount of the plurality of individual systems 20. A specific method of deriving the prediction value of the total imbalance amount is described later in detail.

The incentive is an element serving as motivation which causes the overall energy supply/demand balance (that is, total imbalance amount) of the plurality of individual systems 20 to approach an appropriate value. For example, a decrease amount of the electricity price is set as the incentive. However, the incentive is not limited to the decrease amount of the electricity price, and may appropriately be set. For example, the incentive may be various types of economic benefits, such as points, coupons, or service tickets. Moreover, the incentive may be set through numeralization of an element which is not a simple numerical value. Further, the incentive may include not only the benefit but also a disbenefit (penalty).

The host calculation module 70 divides the derived total imbalance amount by the number of individual systems 20, to thereby derive a unit imbalance amount. The unit imbalance amount indicates an imbalance amount per one individual system 20.

The host calculation module 70 transmits the derived unit imbalance amount and the incentive to each individual system 20. The optimization calculation module 50 of the individual system 20 executes again the optimization calculation based on the received unit imbalance amount and incentive.

As a result, the optimization calculation result in the individual system 20 is substantially corrected in consideration of the overall electric power supply/demand balance of the plurality of individual systems 20 in total. As a result, it is possible to avoid the state in which the electric power supply/demand balance obtained by totaling the plurality of individual systems 20 is no longer optimal. Thus, in the optimization system 1, it is possible to suppress the decrease in the effect of the optimization in the individual system 20 even when the plurality of individual systems 20 are totaled.

Moreover, the host calculation module 70 repeats the derivation of the incentive until the derived prediction value of the total imbalance amount falls within a predetermined range. Further, the optimization calculation module 50 repeats the optimization calculation based on the derived incentive each time the incentive is derived. That is, in the optimization system 1, the substantial correction of the optimization calculation is repeated until the prediction value of the total imbalance amount converges to fall within the predetermined range. As a result, in the optimization system 1, it is possible to suppress the decrease in the effect of the optimization at an early stage.

The repeated operation of the optimization calculation for causing the prediction value of the total imbalance amount to converge to fall within the predetermined range is sometimes referred to as “converging” for the sake of convenience. Moreover, the number of times of the optimization calculation from the start to the end of the converging is sometimes referred to as “number of times of converging.” Further, a period of time required for the converging (period of time required until the prediction value of the total imbalance amount falls within the predetermined range) is sometimes referred to as “converging time.” Operations of the optimization calculation module 50 and the host calculation module 70 are now described in detail.

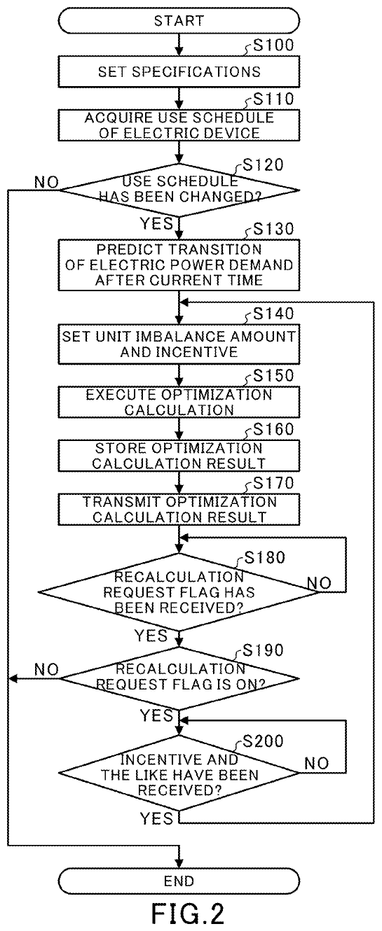

FIG. 2 is a flowchart for illustrating a flow of the operation of the optimization calculation module 50 of the individual system 20. The optimization calculation module 50 starts a series of processing steps of FIG. 2 at the interrupt timing that arrives at the predetermined control cycle (individual control start cycle).

The optimization calculation module 50 first sets specifications being information required for the optimization calculation (Step S100). As the specifications, for example, the objective function, the constraint condition, and other information can be given.

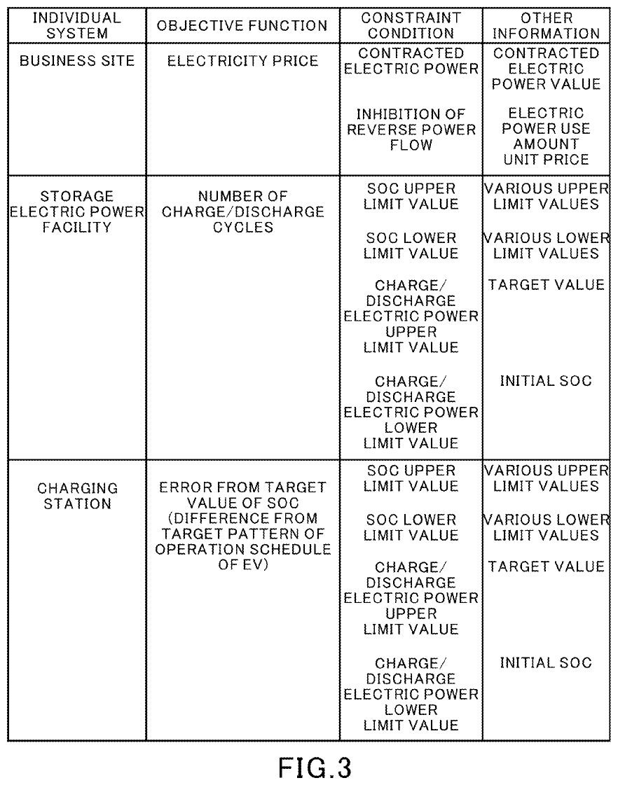

FIG. 3 is a table for showing an example of the specifications. The specifications are not limited to those exemplified in FIG. 3, and may appropriately be set for each individual system 20. As the objective function, the item to be minimized is set. As the constraint condition, the condition to be observed in the optimization calculation is set. Other information is parameters to be used for the optimization calculation.

For example, as shown in FIG. 3, when the individual system 20 to which the optimization calculation module 50 belongs is the business site (individual system 20a), the electricity price is set as the objective function. Moreover, in this case, the contracted electric power and the reverse power flow inhibition are set as the constraint condition. Moreover, in this case, the contracted electric power value and an electric power use amount unit price are used as the other information.

Moreover, for example, when the individual system 20 to which the optimization calculation module 50 belongs is the storage electric power facility (individual system 20b), the number of charge/discharge cycles is set as the objective function. Further, in this case, the SOC upper limit value, the SOC lower limit value, the charge/discharge electric power upper limit value, and the charge/discharge electric power lower limit value are set as the constraint condition. Still further, in this case, various upper limit values, various lower limit values, a target value, and an initial SOC are used as the other information.

Moreover, for example, when the individual system 20 to which the optimization calculation module 50 belongs is the charging station (individual system 20c), the error from the target value of the SOC is set as the objective function. A driving pattern of the EV (in other words, an operation schedule of the charger) may be set as the objective function. Further, in this case, the SOC upper limit value, the SOC lower limit value, the charge/discharge electric power upper limit value, and the charge/discharge electric power lower limit value are set as the constraint condition. Still further, in this case, various upper limit values, various lower limit values, a target value, and an initial SOC are used as the other information.

With reference again to FIG. 2, after the setting of the specifications (Step S100), the optimization calculation module 50 acquires a use schedule of the electric device 30 in a predetermined period after the current time (Step S110). For example, the use schedule of the electric device 30 may be input by an administrator of the individual system 20 or the like, or may be predicted by referring to a past use time and a use history of the electric device 30. The predetermined period after the current time is, for example, from the current time to a time 24 hours later, but is not limited to this example, and may suitably be set.

After that, the optimization calculation module 50 determines whether or not the use schedule of the electric device 30 at the current interrupt timing has been changed from the use schedule of the electric device 30 at the previous interrupt timing (Step S120). When the use schedule has not been changed (“NO” in Step S120), the optimization calculation module 50 finishes the series of processing steps at the current interrupt timing.

When the use schedule has been changed (“YES” in Step S120), the optimization calculation module 50 predicts a transition of the electric power demand in the predetermined period after the current time (for example, from the current time to the time 24 hours later) based on the current use schedule of the electric device 30 (Step S130).

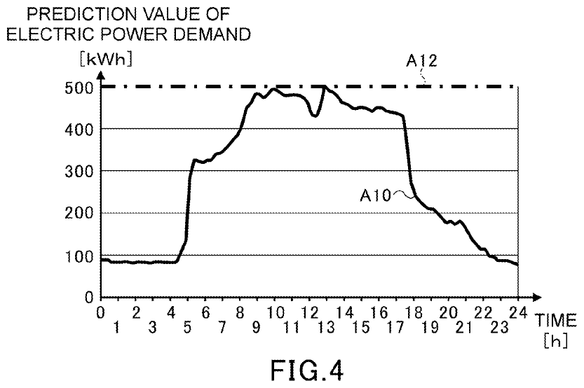

FIG. 4 is a graph for showing an example of the transition of the prediction value of the electric power demand. FIG. 4 shows the case in which the individual system 20 to which the optimization calculation module 50 belongs is the business site (individual system 20a). A solid line A10 indicates the transition of the prediction value of the electric power demand. A one-dot chain line A12 indicates the contracted electric power. As shown in FIG. 4, the prediction value of the electric power demand stays equal to or lower than the contracted electric power.

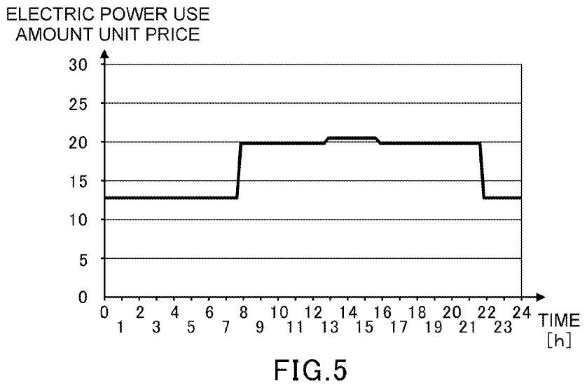

FIG. 5 is a graph for showing an example of a transition of the electric power use amount unit price. As shown in FIG. 5, the electric power use amount unit price varies in accordance with the time.

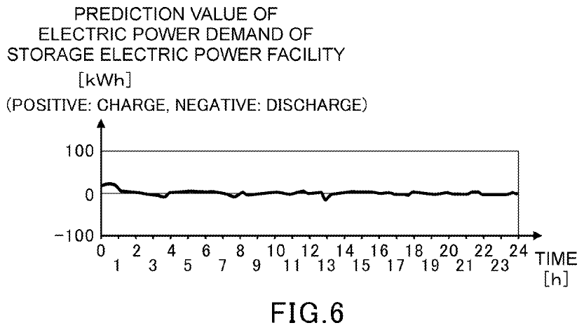

FIG. 6 is a graph for showing another example of the transition of the prediction value of the electric power demand. FIG. 6 shows the case in which the individual system 20 to which the optimization calculation module 50 belongs is the storage electric power facility (individual system 20b). In FIG. 6, the charge of the battery in the storage electric power facility is indicated as a positive electric power demand. The discharge thereof is indicated as a negative electric power demand. As shown in FIG. 6, the charge and the discharge are appropriately repeated in the storage electric power facility.

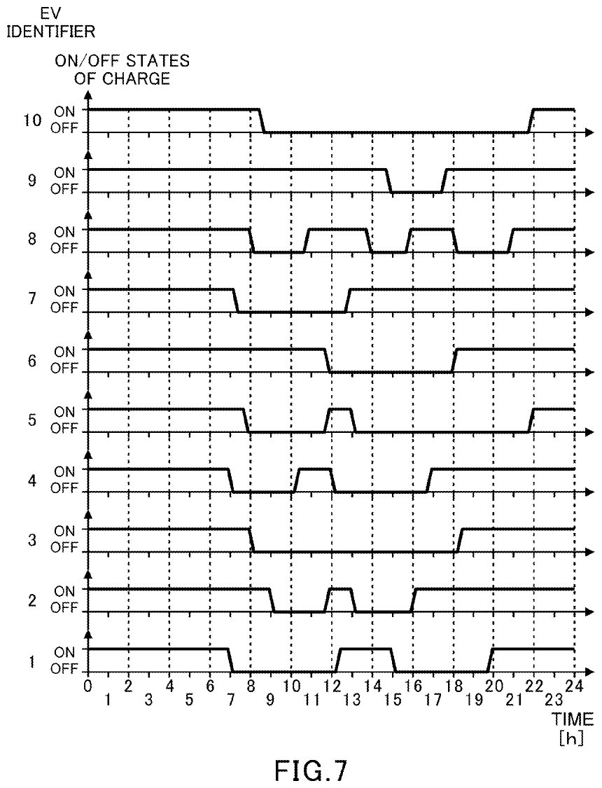

FIG. 7 is a graph for showing an example of an ON state and an OFF state of the charge of batteries of the vehicles. FIG. 7 shows an example of operation schedules of the vehicles (EVs), that is, use schedules of the chargers in the charging station. In FIG. 7, a case of ten EVs is exemplified. The number of EVs is not limited to this example, and can suitably be set.

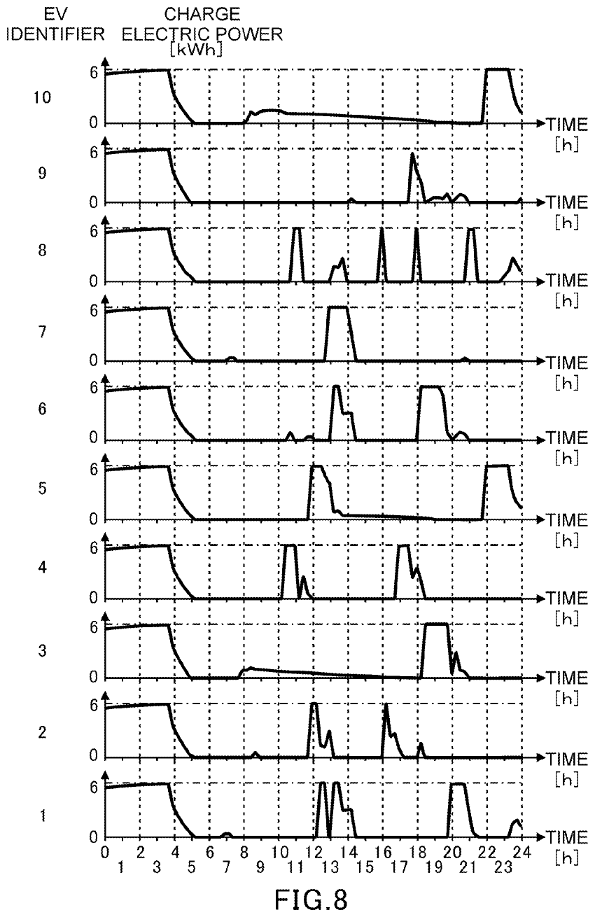

FIG. 8 is a graph for showing another example of the transitions of the prediction values of the electric power demands. FIG. 8 shows the case in which the individual system 20 to which the optimization calculation unit 50 belongs is the charging station (individual system 20c). In FIG. 8, the prediction values are indicated so that the prediction values correspond to the respective ten EVs of FIG. 7. The transitions of the prediction values of the electric power demands of FIG. 8 are derived based on the operation schedules of the EVs of FIG. 7. As shown in FIG. 8, charge start timings and charge times of the EVs are different among the EVs.

With reference again to FIG. 2, after the prediction of the electric power demand (Step S130), the optimization calculation module 50 acquires and sets the unit imbalance amount and the incentive (Step S140). When the processing step of Step S140 is executed for the first time at the current interrupt timing, predetermined initial values are set to the unit imbalance amount and the incentive. Moreover, as described later, when the unit imbalance amount and the incentive are received from the host system 12, the received unit imbalance amount and incentive are set.

Next, the optimization calculation module 50 uses the set objective function, constraint condition, unit imbalance amount, and incentive to execute the optimization calculation (Step S150). In the optimization calculation, for example, a weighted sum of the objective function, the incentive, and a function for reducing the unit imbalance amount is minimized under the constraint condition.

The function for reducing the unit imbalance amount is sometimes referred to as “unit imbalance reduction function.” The unit imbalance reduction function can be derived as given by, for example, Expression (1). The unit imbalance reduction function is used to cause the optimization calculation to converge.

∥P*ₙ(k)−P*ₙ₋₁(k)+P^{T}(k)/N∥² (1)

In Expression (1), “k” is a parameter indicating the time. For example, k=0 indicates the current time. Moreover, “k” is counted up each time one hour has elapsed. For example, k=1 corresponds to a time one hour later from the current time, and k=24 corresponds to a time 24 hours later from the current time.

Moreover, N indicates the number of individual systems 20. The example of FIG. 1 is formed of the three individual systems 20a, 20b, and 20c, and hence N is set to 3. P^{T}(k)/N indicates the unit imbalance amount. P^{T}(k) is the prediction value of the total imbalance amount at a time “k” hours later from the current time derived as given by Expression (2) described later. When the processing step of Step S150 is executed for the first time at the current interrupt timing, P^{T}(k)/N corresponds to the initial value of the unit imbalance amount set in Step S140. Moreover, as described later, when the unit imbalance amount is received from the host system 12, P^{T}(k)/N is updated with the received unit imbalance amount.

Moreover, “n” indicates the number of times of the optimization calculation (the number of times of converging) at the current interrupt timing. When the processing step of Step S150 is executed for the first time at the current interrupt timing, “n” is set to 1. Moreover, P* indicates the prediction value of the electric power demand for each individual system 20. For example, when the individual system 20 is the business site (individual system 20a), P* corresponds to a prediction value P^{BU} of the electric power demand of the business site. Moreover, P*ₙ(k)−P*ₙ₋₁(k) corresponds to a value obtained by subtracting an (n−1)th prediction value of the electric power demand from an n-th prediction value of the electric power demand at the current interrupt timing.

When the optimization calculation is executed in Step S150, the optimization calculation result is derived. The optimization calculation result is derived as, for example, the transition of the prediction value of the electric power demand in the predetermined period after the current time in the individual system 20 to which the optimization calculation module 50 belongs.

After the optimization calculation is executed once in Step S150, the optimization calculation module 50 stores the optimization calculation result in the storage unit 42 (Step S160). After that, the optimization calculation module 50 transmits the optimization calculation result to the host system 12 through the communication unit 40 (Step S170).

After the transmission of the optimization calculation result, the optimization calculation module 50 waits until reception of a recalculation request flag (“NO” in Step S180). The recalculation request flag indicates whether or not it is requested to execute again the optimization calculation. When the recalculation request flag has not been received within a predetermined period of time since the transmission of the optimization calculation result, the optimization calculation module 50 may finish the series of processing steps after the predetermined period of time has elapsed (timeout).

When the recalculation request flag has been received (“YES” in Step S180), the optimization calculation module 50 determines whether or not the received recalculation request flag is in an ON state (Step S190). When the recalculation request flag is in an OFF state (“NO” in Step S190), the optimization calculation module 50 considers that the recalculation is not required (the subsequent converging is not required), and finishes the series of processing steps.

When the recalculation request flag is in the ON state (“YES” in Step S190), the optimization calculation module 50 considers that the recalculation is required (converging is required), and advances the process to the processing step of Step S200.

In Step S200, the optimization calculation module 50 waits until the unit imbalance amount and the incentive are received from the host system 12 (“NO” in Step S200). When the unit imbalance amount and the incentive have not been received within a predetermined period of time since the transmission of the optimization calculation result, the optimization calculation module 50 may finish the series of processing steps after the predetermined period of time has elapsed (timeout).

When the unit imbalance amount and the incentive have been received (“YES” in Step S200), the optimization calculation module 50 returns the process to Step S140. Then, the optimization calculation module 50 updates the set values of the unit imbalance amount and the incentive to the received unit imbalance amount and incentive (Step S140). After that, the optimization calculation module 50 uses the updated unit imbalance amount and incentive to again execute the optimization calculation (Step S150).

As described above, in the individual system 20, the optimization calculation is repeated (converging is executed) until the request for the recalculation from the host system 12 is no longer made at the current interrupt timing. The converging may be finished earlier by restricting execution of other interrupt control during the series of processing steps of FIG. 2.

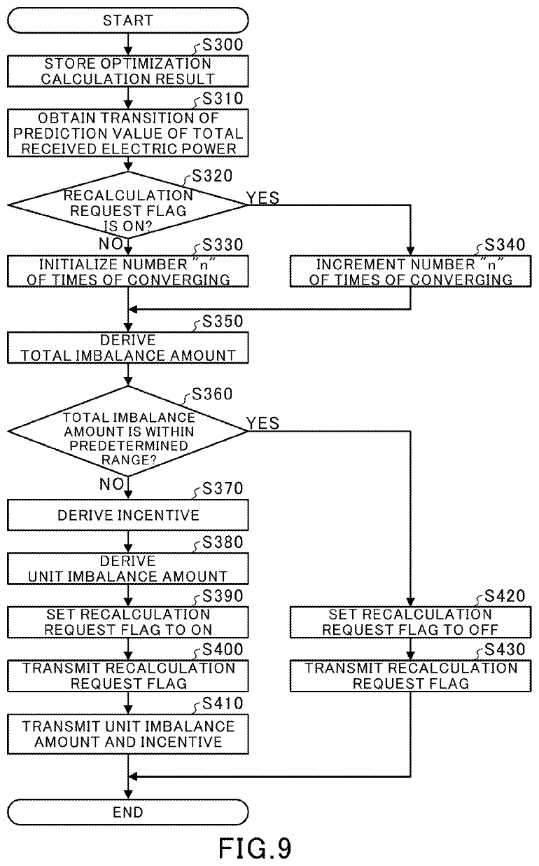

FIG. 9 is a flowchart for illustrating a flow of an operation of the host calculation module 70. When the host calculation module 70 receives the optimization calculation result from any one of the individual systems 20, the host calculation module 70 starts a series of processing steps of FIG. 9.

The host calculation module 70 first stores the received optimization calculation result in the storage unit 62 in association with the individual system 20 being the transmission source (Step S300). In this case, the optimization calculation result is asynchronously derived in each individual system 20, and hence the host calculation module 70 receives a plurality of optimization calculation results for the respective individual systems 20 at timings different from one another. The host calculation module 70 stores, in the storage unit 62, the optimization calculation results which are received at different timings each time each of the optimization calculation results is received. Thus, in the storage unit 62, the latest values of the plurality of optimization calculation results for the respective individual systems 20 are held.

Next, the host calculation module 70 obtains a transition of a prediction value of a total received electric power in a predetermined period after the current time (Step S310). Received electric power is electric power supplied from the electric power system 22 to the individual system 20. The total received electric power corresponds to a value obtained by adding the received electric power of each individual system 20 for the plurality of individual systems 20 in total. That is, the total received electric power corresponds to a total electric power supply amount over the plurality of individual systems 20.

The host calculation module 70, for example, may estimate a total received electric power in the future from the past received electric power of each individual system 20, to thereby obtain the transition of the prediction value of the total received electric power. Moreover, a transition of a prediction value of the received electric power may be derived in each individual system 20, and the host calculation module 70 may obtain the transition of the prediction value of the received electric power from each individual system 20 and add the transitions of the prediction values to one another, to thereby obtain the transition of the prediction value of the total received electric power.

Next, the host calculation module 70 determines whether or not the recalculation request flag is in the ON state (Step S320). That is, in Step S320, it is determined whether or not the received optimization calculation result is an optimization calculation result in the course of the converging.

When the recalculation request flag is in the OFF state (“NO” in Step S320), the host calculation module 70 initializes the number “n” of times of converging (sets “n” to 1) (Step S330). When the recalculation request flag is in the ON state (“YES” in Step S320), the host calculation module 70 increments the number “n” of times of converging (Step S340).

After Step S330 or Step S340, the host calculation module 70 derives a prediction value of a total imbalance amount in a predetermined period after the current time based on the received optimization calculation result and the transition of the prediction value of the total received electric power (Step S350). Specifically, the prediction value of the total imbalance amount is derived as given by Expression (2).

$${P}^{T} ( k ) = {P}^{N E T} ( k ) - {P}^{BU} ( k ) - {P}^{BA} - {{\sum }^{10}}_{i = 1} {P}_{i}^{EV} ( k ) \qquad ( 2 )$$

In Expression (2), “k” indicates the time as in Expression (1). Moreover, P^{T}(k) indicates a prediction value of the total imbalance amount at the time “k” hours later from the current time. P^{NET}(k) indicates the total received electric power at the time “k” hours later from the current time.

P^{BU}(k) indicates a prediction value of the electric power demand in the business site (individual system 20a) at the time “k” hours later from the current time. That is, P^{BU}(k) corresponds to the optimization calculation result of the individual system 20a. P^{BU}(k) is obtained through the optimization calculation so that P^{NET}(k) being the total received electric power observes the constraint condition (such as the contracted electric power and the reverse power flow inhibition) of the business site (individual system 20a) exemplified in FIG. 3, and the objective function (such as electricity price) is minimized.

P^{BA}(k) indicates a prediction value of the electric power demand in the storage electric power facility (individual system 20b) at the time “k” hours later from the current time. That is, P^{BA}(k) corresponds to the optimization calculation result of the individual system 20b.

P^{EV}ᵢ(k) indicates a prediction value of the electric power demand in an i-th EV at the time “k” hours later from the current time. Moreover, ΣP^{EV}ᵢ(k) indicates a sum obtained by adding the prediction values of the electric power demands in the EVs for all of the EVs. That is, ΣP^{EV}ᵢ(k) corresponds to the optimization calculation result of the individual system 20c. An upper limit of “i” is set to 10 in Expression (2), but can suitably be set based on the number of EVs.

As given by Expression (2), the host calculation module 70 subtracts the prediction values (optimization calculation results) of the electric power demands of the respective individual systems 20 from the prediction value of the total received electric power, to thereby derive the prediction value of the total imbalance amount. The host calculation module 70 executes this calculation from the current time (k=0) to a time predetermined hours later (for example, k=24), to thereby derive the transition of the prediction value of the total imbalance amount.

The total imbalance amount is a positive value when the prediction value of the total received electric power is larger than the sum of the prediction values of the electric power demands of the respective individual systems 20. Meanwhile, the total imbalance amount is a negative value when the sum of the prediction values of the electric power demands of the respective individual systems 20 is larger than the prediction value of the total received electric power.

Moreover, for the optimization calculation results (transitions of the prediction values of the electric power demands) in the individual systems 20 other than the individual system 20 to which the optimization calculation result received the current time belongs, the latest values are read out from the storage unit 62 to be used.

After the derivation of the total imbalance amount, the optimization calculation module 50 determines whether or not the prediction value of the total imbalance amount is within a predetermined range (Step S360). For example, the optimization calculation module 50 determines that the prediction value of the total imbalance amount is within the predetermined range when the total imbalance amount is maintained within the predetermined range for a predetermined period (for example, k=0 to 24) after the current time. When an absolute value of the prediction value of the total imbalance amount is less than a predetermined value, it may be considered that the prediction value of the total imbalance amount is within the predetermined range.

When the prediction value of the total imbalance amount is within the predetermined range (“NO” in Step S360), the optimization calculation module 50 derives the incentive based on the prediction value of the total imbalance amount (Step S370). Specifically, the incentive is derived as given by Expression (3).

λₙ(k)=λₙ₋₁(k)+ρP^{T}(k) (3)

In Expression (3), “k” indicates the time as in Expression (2). Moreover, “n” indicates the number of times of converging (the number “n” of times of converging in Step S330 or Step S340). Further, λₙ(k) indicates the incentive at the time “k” hours later from the current time when the number of times of converging is “n.” Still further, λₙ₋₁(k) indicates the incentive at the time “k” hours later from the current time when the number of times of converging is “n−1.” Yet further, ρ is a coefficient set in advance, and is set to a value larger than 0. P^{T}(k) indicates the prediction value of the total imbalance amount derived as given by Expression (2).

As given by Expression (3), the host calculation module 70 adds a value obtained by multiplying the derived prediction value of the total imbalance amount by a predetermined coefficient to the incentive for the previous time (n−1), to thereby derive the incentive for the current time (n). The host calculation module 70 executes this calculation from the current time (k=0) to a time predetermined hours later (for example, k=24), to thereby derive the transition of the prediction value of the incentive.

For example, when the prediction value of the total imbalance amount indicates an electric power surplus (P^{T}(k)>0), the incentive (λₙ(k)) increases in response to the prediction value of the total imbalance amount. For example, when the incentive is an electricity price, an increase amount of the incentive corresponds to a decrease amount (price reduction amount) of the electricity price.

Conversely, for example, when the prediction value of the total imbalance amount indicates an electric power shortage (P^{T}(k)<0), the incentive (λₙ(k)) decreases in response to the prediction value of the total imbalance amount. For example, when the incentive is an electricity price, a decrease amount of the incentive corresponds to an increase amount (price increase amount) of the electricity price.

After the derivation of the incentive, the host calculation module 70 derives a prediction value of the unit imbalance amount (Step S380). The prediction value of the unit imbalance amount is obtained by dividing the prediction value of the total imbalance amount derived in Step S350 by the number of individual systems 20.

Next, the host calculation module 70 sets the recalculation request flag to the ON state (Step S390). The recalculation request flag is maintained in the ON state until the recalculation request flag is set to the OFF state.

Next, the host calculation module 70 transmits the recalculation request flag in the ON state to the individual system 20 being the transmission source of the optimization calculation result through the communication unit 60 (Step S400). After that, the host calculation module 70 transmits the prediction value of the unit imbalance amount derived in Step S380 and the incentive derived in Step S370 to the individual system 20 being the transmission source of the optimization calculation result (Step S410).

As a result, the optimization calculation is executed again based on the transmitted prediction value of the unit imbalance amount and the transmitted incentive in the individual system 20 being the transmission source of the optimization calculation result (see FIG. 2). After that, the host calculation module 70 restarts the series of processing steps of FIG. 9 in response to the reception of the optimization calculation result obtained through the recalculation. That is, the converging is continued.

Moreover, when the prediction value of the total imbalance amount is smaller than the predetermined value in Step S360 (“YES” in Step S360), the host calculation module 70 sets the recalculation request flag to the OFF state (Step S420). The recalculation request flag is maintained in the OFF state until the recalculation request flag is set to the ON state.

Next, the host calculation module 70 transmits the recalculation request flag in the OFF state to the individual system 20 being the transmission source of the optimization calculation result through the communication unit 60 (Step S430).

When the recalculation request flag in the OFF state is transmitted, the recalculation of the optimization calculation is not executed in the individual system 20 being the transmission source of the optimization calculation result, and the converging is finished.

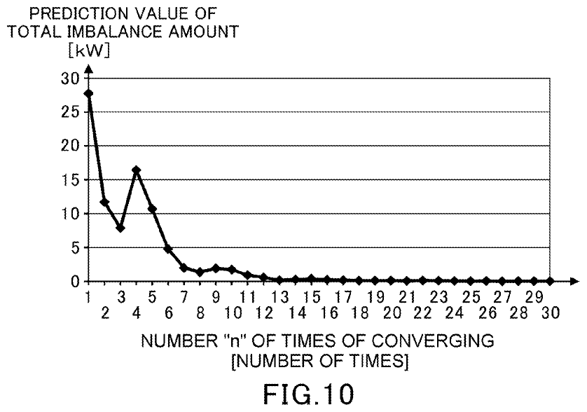

FIG. 10 is a graph for showing an example of a relationship between the number “n” of times of converging and the prediction value of the total imbalance amount. As shown in FIG. 10, as the number “n” of times of converging increases, the prediction value of the total imbalance amount can be brought to a value close to zero.

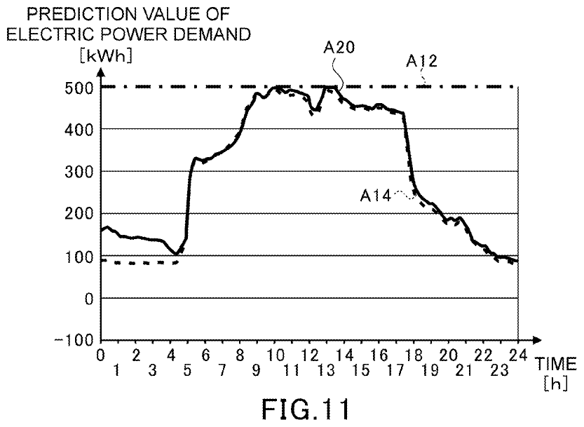

FIG. 11 is a graph for showing an effect of the optimization system 1. A solid line A20 of FIG. 11 indicates a transition of a prediction value of an electric power demand of the plurality of individual systems 20 in total at the time when the prediction value of the total imbalance amount is brought into a predetermined range. That is, the solid line A20 corresponds to a sum of the optimization calculation results of the individual systems 20 obtained in consideration of the prediction value of the total imbalance amount. A broken line A14 of FIG. 11 is the solid line A10 of FIG. 4 represented as the broken line.

As shown in FIG. 11, the prediction value (solid line A20) of the electric power demand of the plurality of individual systems 20 in total is less than the contracted electric power (one-dot chain line A12) over a predetermined period (for example, 24 hours) after the current time. For example, even when the prediction value of the electric power demand increases in the charging station (individual system 20c) at a time approximately 13.5 hours later from the current time, the prediction value of the electric power demand of the plurality of individual systems 20 in total at this time can be reduced to a value less than the contracted electric power.

As described above, in the optimization system 1 according to this embodiment, the host system 12 which can communicate to and from the individual systems 20 is provided. The optimization calculation module 50 of the individual system 20 executes the optimization calculation, and transmits the optimization calculation result to the host system 12. The host calculation module 70 of the host system 12 derives the incentive based on the plurality of optimization calculation results each derived by a corresponding one of the individual systems 20. Then, the optimization calculation module 50 of the individual system 20 again executes the optimization calculation based on the incentive derived by the host calculation module 70.

As a result, in the optimization system 1 according to this embodiment, the optimization calculation result of each individual system 20 can substantially be corrected in accordance with the incentive. As a result, in the optimization system 1 according to this embodiment, while the energy demand can be optimized in each individual system 20, the energy demand can also be optimized when the energy demands of the plurality of individual systems 20 are totaled. Thus, the optimization system 1 according to this embodiment can suppress the decrease in effect of the optimization calculation.

Moreover, the host calculation module 70 derives the prediction value of the total imbalance amount based on the plurality of optimization calculation results. Then, the host calculation module 70 derives the incentive based on the prediction value of the total imbalance amount. Thus, in the optimization system 1 according to this embodiment, an appropriate incentive can be derived. As a result, in the optimization system 1 according to this embodiment, the decrease in effect of the optimization calculation can appropriately be suppressed.

Moreover, the host calculation module 70 repeats the derivation of the incentive until the derived prediction value of the total imbalance amount falls within the predetermined range. Further, the optimization calculation module 50 repeats the optimization calculation based on the derived incentive each time the incentive is derived. As a result, in the optimization system 1 according to this embodiment, it is possible to suppress the decrease in the effect of the optimization at an early stage.

Further, the optimization calculation module 50 starts the optimization calculation at each interrupt timing that arrives at a predetermined control cycle. Moreover, the host calculation module 70 starts the calculation based on the optimization calculation result at the timing of the reception of the optimization calculation result from any one of the individual systems 20. As a result, in the optimization system 1 according to this embodiment, the optimization calculation result is appropriately updated substantially in real time.

The embodiment has been described above with reference to the attached drawings, but it should be understood that the present disclosure is not limited to the embodiment described above. It is apparent that those skilled in the art may arrive at various alternation examples and modification examples within the scope of claims, and those examples are construed as naturally falling within the technical scope of the present disclosure.

For example, in the embodiment described above, the charging station may be divided into a plurality of individual systems 20 based on applications of the EVs, types of the EVs, and the like.

Moreover, in the embodiment described above, the charging station being an example of the individual system 20 charges the batteries of the EVs. However, the individual system 20 is not limited to the system which charges the battery of the EV, but may be a system which charges a battery of an electric mobility. For example, the individual system 20 may be a system which charges a battery of an aerial vehicle such as a drone, an underwater thruster such as an autonomous underwater vehicle (AUV), and the like.

Moreover, in the embodiment described above, the transition of the prediction value of the electric power demand is derived as the optimization calculation result. However, the type of the optimization calculation result is not limited to the transition of the prediction value of the electric power demand. For example, as the optimization calculation result, a transition of a prediction value of a demand relating to energy, such as an amount of heat or gas, may be derived. In this case, the electric power system 22 is replaced with an energy source. The electric device 30 is replaced with a device connected to the energy source. The device receives energy from the energy source, or transmits energy to the energy source. The optimization calculation module 50 executes such optimization calculation that a parameter of the energy through the device is minimized. The host calculation module 70 derives a prediction value of a total imbalance amount based on a transition of a prediction value of an energy demand for each of the plurality of individual systems 20. The prediction value of the total imbalance amount is derived by subtracting a total demand amount of the energy from a total supply amount of the energy. The host calculation module 70 derives an incentive based on the prediction value of the total imbalance amount. The optimization calculation module 50 again executes the optimization calculation based on the incentive derived by the host calculation module 70.

What is claimed is:

1. An optimization system, comprising:
a plurality of individual systems; and
a host system configured to communicate to and from the plurality of individual systems,
wherein each of the plurality of individual systems includes:
a device which is connected to an energy source, and is configured to receive energy from the energy source, or transmit energy to the energy source; and
an optimization calculation module configured to execute optimization calculation so that an objective function is minimized under a state in which parameters of the energy through the device are set to the objective function and a constraint condition, respectively,
wherein the host system includes a host calculation module configured to derive an incentive based on a plurality of optimization calculation results each derived by a corresponding one of the plurality of individual systems, and
wherein the optimization calculation module is configured to again execute the optimization calculation based on the incentive derived by the host calculation module.

2. The optimization system according to claim 1,
wherein the plurality of optimization calculation results each include a prediction value of a demand for energy received from the energy source in a corresponding one of the plurality of individual systems, and
wherein the host calculation module is configured to derive a prediction value of a total imbalance amount being an index indicating an energy supply/demand balance obtained by totaling the plurality of individual systems based on the plurality of optimization calculation results, and to derive the incentive based on the prediction value of the total imbalance amount.

3. The optimization system according to claim 2,
wherein the host calculation module is configured to repeat the derivation of the incentive until the derived prediction value of the total imbalance amount falls within a predetermined range, and
wherein the optimization calculation module is configured to repeat the optimization calculation based on the derived incentive each time the incentive is derived.

4. The optimization system according to claim 1,
wherein the optimization calculation module is configured to start the optimization calculation at each interrupt timing that arrives at a predetermined control cycle, and
wherein the host calculation module is configured to start calculation based on one of the plurality of optimization calculation results at a timing of reception of the one of the plurality of optimization calculation results from any one of the plurality of individual systems.
